(19) United States
(12) Patent Application Publication
(10) Pub. No.: US 2026/0164275 A1
(43) Pub. Date: Jun. 11, 2026

(54) INDICATING A CHANGE IN AT LEAST A SUBSET OF CHANNEL STATE INFORMATION

(71) Applicant: Nokia Technologies Oy, Espoo (FI)

(72) Inventors: Tero HENTTONEN, Espoo (FI); Zexian LI, Espoo (FI); Karri Markus RANTA-AHO, Espoo (FI); Roman KOVALCHUKOV, Espoo (FI)

(21) Appl. No.: 18/975,117

(22) Filed: Dec. 10, 2024

(51) Int. Cl. H04W 24/10; H04B 7/06; H04W 24/08

(52) U.S. Cl. CPC H04W 24/10; H04B 7/0626; H04W 24/08

(57) ABSTRACT

Disclosed is a method comprising evaluating a set of channel state information; and determining, based at least on the evaluation, whether to transmit, to a network device, a report comprising information that indicates a change in at least a subset of the channel state information compared to previously reported channel state information.

### FIELD

The following example embodiments relate to wireless communication.

### BACKGROUND

Channel state information refers to data about the current conditions of the wireless communication channel between a transmitter and a receiver.

### SUMMARY

The scope of protection sought for various example embodiments is set out by the claims. According to some aspects, there is provided the subject matter of the independent claims. Some further aspects are defined in the dependent claims. The example embodiments and features, if any, described in this specification that do not fall under the scope of the claims are to be interpreted as examples useful for understanding various embodiments.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

In the following, various example embodiments will be described in greater detail with reference to the accompanying drawings, in which

FIG. 1 illustrates an example of a wireless communication network;

FIG. 2A illustrates an example of a short channel state information report;

FIG. 2B illustrates an example of a short channel state information report;

FIG. 2C illustrates an example of a short channel state information report;

FIG. 3 illustrates a signal flow diagram;

FIG. 4 illustrates a signal flow diagram;

FIG. 5 illustrates a signal flow diagram;

FIG. 6 illustrates a signal flow diagram;

FIG. 7 illustrates a flow chart;

FIG. 8 illustrates a flow chart;

FIG. 9 illustrates an example of an apparatus; and

FIG. 10 illustrates an example of an apparatus.

### DETAILED DESCRIPTION

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments within the scope of the claims. Furthermore, the words “comprising” and “including” should be understood as not limiting the described embodiments to consist of only those features that have been mentioned, and such embodiments may also contain features that have not been specifically mentioned. Reference numbers, in the description and/or in the claims, serve to illustrate the embodiments with reference to the drawings, without limiting the embodiments to these examples only.

Some example embodiments described herein may be implemented in a wireless communication network comprising a radio access network based on one or more of the following radio access technologies (RATs): global system for mobile communications (GSM) or any other second generation (2G) radio access technology, universal mobile telecommunication system (UMTS, 3G) based on basic wideband-code division multiple access (W-CDMA), high-speed packet access (HSPA), long term evolution (LTE), LTE-Advanced, fourth generation (4G), fifth generation (5G), 5G new radio (NR), 5G-Advanced (i.e., 3GPP NR Rel-18 and beyond), or sixth generation (6G). Some examples of radio access networks include the universal mobile telecommunications system (UMTS) radio access network (UTRAN), the evolved universal terrestrial radio access network (E-UTRA), or the next generation radio access network (NG-RAN). The wireless communication network may further comprise a core network, and some example embodiments may also be applied to network functions of the core network.

It should be noted that the embodiments are not restricted to the wireless communication network given as an example, but a person skilled in the art may also apply the solution to other wireless communication networks or systems provided with necessary properties. For example, some example embodiments may also be applied to a communication system based on IEEE 802.11 specifications, or a communication system based on IEEE 802.15 specifications. IEEE is an abbreviation for the Institute of Electrical and Electronics Engineers.

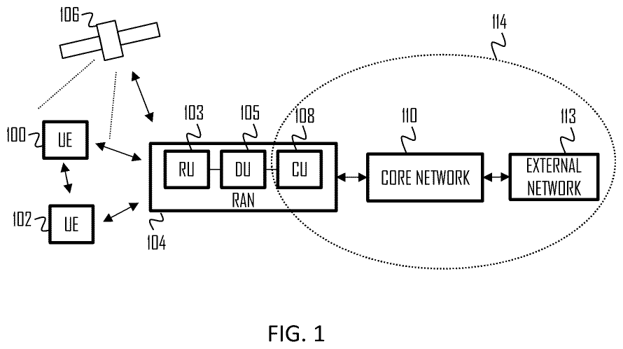

FIG. 1 depicts an example of a simplified wireless communication network showing some physical and logical entities. The connections shown in FIG. 1 may be physical connections or logical connections. It is apparent to a person skilled in the art that the wireless communication network may also comprise other physical and logical entities than those shown in FIG. 1.

The example embodiments described herein are not, however, restricted to the wireless communication network given as an example but a person skilled in the art may apply the example embodiments described herein to other wireless communication networks provided with necessary properties.

The example wireless communication network shown in FIG. 1 includes a radio access network (RAN) and a core network 110.

FIG. 1 shows user equipment (UE) 100, 102 configured to be in a wireless connection on one or more communication channels in a radio cell with an access node 104 of a radio access network.

The access node 104 may comprise a computing device configured to control the radio resources of the access node 104 and to be in a wireless connection with one or more UEs 100, 102. The access node 104 may also be referred to as a base station, a base transceiver station (BTS), an access point, a cell site, a network node, a radio access network node, a RAN node, or a network device.

The access node 104 may be, for example, an evolved NodeB (abbreviated as eNB or eNodeB), or a next generation evolved NodeB (abbreviated as ng-eNB), or a next generation NodeB (abbreviated as gNB or gNodeB), providing the radio cell. The access node 104 may include or be coupled to transceivers. From the transceivers of the access node 104, a connection may be provided to an antenna unit that establishes a bi-directional radio link to one or more UEs 100, 102. The antenna unit may comprise an antenna or antenna element, or a plurality of antennas or antenna elements.

The wireless connection (e.g., radio link) from a UE 100, 102 to the access node 104 may be called uplink (UL) or reverse link, and the wireless connection (e.g., radio link) from the access node 104 to the UE 100, 102 may be called downlink (DL) or forward link. A UE 100 may also communicate directly with another UE 102, and vice versa, via a wireless connection generally referred to as a sidelink (SL). It should be appreciated that the access node 104 or its functionalities may be implemented by using any node, host, server, access point or other entity suitable for providing such functionalities.

The radio access network may comprise more than one access node 104, in which case the access nodes may also be configured to communicate with one another over wired or wireless links. These links between access nodes may be used for sending and/or receiving control plane signaling and also for routing data from one access node to another access node.

The access node 104 may further be connected to a core network (CN) 110. The core network 110 may comprise an evolved packet core (EPC) network and/or a 5^{th} generation core network (5GC). The EPC may comprise network entities, such as a serving gateway (S-GW for routing and forwarding data packets), a packet data network gateway (P-GW) for providing connectivity of UEs to external packet data networks, and/or a mobility management entity (MME). The 5GC may comprise one or more network functions, such as at least one of: a user plane function (UPF), an access and mobility management function (AMF), a location management function (LMF), and/or a session management function (SMF).

The core network 110 may also be able to communicate with one or more external networks 113, such as a public switched telephone network or the Internet, or utilize services provided by them. For example, in 5G wireless communication networks, the UPF of the core network 110 may be configured to communicate with an external data network via an N6 interface. In LTE wireless communication networks, the P-GW of the core network 110 may be configured to communicate with an external data network.

It should also be understood that the distribution of functions between core network operations and access node operations may differ in future wireless communication networks compared to that of the LTE or 5G, or even be non-existent.

The illustrated UE 100, 102 is one type of an apparatus to which resources on the air interface may be allocated and assigned. The UE 100, 102 may also be called a wireless communication device, a subscriber unit, a mobile station, a remote terminal, an access terminal, a user terminal, a terminal device, or a user device, just to mention but a few names. In this description, the terms “UE” and “user device” may be used interchangeably.

The UE 100, 102 may be a computing device operating with or without a subscriber identification module (SIM), including, but not limited to, the following types of computing devices: a mobile phone, a smartphone, a personal digital assistant (PDA), a handset, a computing device comprising a wireless modem (e.g., an alarm or measurement device, etc.), a laptop computer, a desktop computer, a tablet, a game console, a notebook, a multimedia device, a reduced capability (RedCap) device, a wearable device (e.g., a watch, earphones or eyeglasses) with radio parts, a sensor comprising a wireless modem, or a computing device comprising a wireless modem integrated in a vehicle.

It should be appreciated that the UE 100, 102 may also be a nearly exclusive uplink-only device, of which an example may be a camera or video camera loading images or video clips to a network. The UE 100, 102 may also be a device having capability to operate in an Internet of Things (IoT) network, which is a scenario in which objects may be provided with the ability to transfer data over a network without requiring human-to-human or human-to-computer interaction.

The wireless communication network may also be able to support the usage of cloud services. For example, at least part of core network operations may be carried out as a cloud service (this is depicted in FIG. 1 by “cloud” 114). The UE 100, 102 may also utilize the cloud 114. In some applications, the computation for a given UE may be carried out in the cloud 114 or in another UE.

The wireless communication network may also comprise a central control entity, such as a network management system (NMS), or the like. The NMS is a centralized suite of software and hardware used to monitor, control, and administer the network infrastructure. The NMS is responsible for a wide range of tasks such as fault management, configuration management, security management, performance management, and accounting management. The NMS enables network operators to efficiently manage and optimize network resources, ensuring that the network delivers high performance, reliability, and security.

5G enables using multiple-input and multiple-output (MIMO) antennas in the access node 104 and/or the UE 100, 102, many more base stations or access nodes than an LTE network (a so-called small cell concept), including macro sites operating in co-operation with smaller stations and employing a variety of radio technologies depending on service needs, use cases and/or spectrum available. 5G wireless communication networks may support a wide range of use cases and related applications including video streaming, augmented reality, different ways of data sharing and various forms of machine-type applications, such as (massive) machine-type communications (mMTC), including vehicular safety, different sensors and real-time control.

In 5G wireless communication networks, access nodes and/or UEs may have multiple radio interfaces, such as below 6 gigahertz (GHz), centimeter wave (cmWave) and millimeter wave (mmWave), and also being integrable with legacy radio access technologies, such as LTE. Integration with LTE may be implemented, for example, as a system, where macro coverage may be provided by LTE, and 5G radio interface access may come from small cells by aggregation to LTE. In other words, a 5G wireless communication network may support both inter-RAT operability (such as interoperability between LTE and 5G) and inter-RI operability (inter-radio interface operability, such as between below 6 GHz, cmWave, and mmWave).

5G wireless communication networks may also apply network slicing, in which multiple independent and dedicated virtual sub-networks (network instances) may be created within the same physical infrastructure to run services that have different requirements on latency, reliability, throughput and mobility.

In one embodiment, an access node 104 may comprise: a radio unit (RU) 103 comprising a radio transceiver (TRX), i.e., a transmitter (Tx) and a receiver (Rx); one or more distributed units (DUs) 105 that may be used for the so-called Layer 1 (L1) processing and real-time Layer 2 (L2) processing; and a central unit (CU) 108 (also known as a centralized unit) that may be used for non-real-time L2 and Layer 3 (L3) processing. The CU 108 may be connected to the one or more DUs 105 for example via an F1 interface. Such an embodiment of the access node 104 may enable the centralization of CUs relative to the cell sites and DUs, whereas DUs may be more distributed and may even remain at cell sites. The CU and DU together may also be referred to as baseband or a baseband unit (BBU). The CU and DU may also be comprised in a radio access point (RAP).

The CU 108 may be a logical node hosting radio resource control (RRC), service data adaptation protocol (SDAP) and/or packet data convergence protocol (PDCP), of the NR protocol stack for an access node 104. The CU 108 may comprise a control plane (CU-CP), which may be a logical node hosting the RRC and the control plane part of the PDCP protocol of the NR protocol stack for the access node 104. The CU 108 may further comprise a user plane (CU-UP), which may be a logical node hosting the user plane part of the PDCP protocol and the SDAP protocol of the CU for the access node 104.

The DU 105 may be a logical node hosting radio link control (RLC), medium access control (MAC) and/or physical (PHY) layers of the NR protocol stack for the access node 104. The operations of the DU 105 may be at least partly controlled by the CU 108. It should also be understood that the distribution of functions between the DU 105 and the CU 108 may vary depending on the implementation.

Cloud computing systems may also be used to provide the CU 108 and/or DU 105. A CU provided by a cloud computing system may be referred to as a virtualized CU (vCU). In addition to the vCU, there may also be a virtualized DU (vDU) provided by a cloud computing system. Furthermore, there may also be a combination, where the DU may be implemented on so-called bare metal solutions, for example application-specific integrated circuit (ASIC) or customer-specific standard product (CSSP) system-on-a-chip (SoC).

Edge cloud may be brought into the radio access network by utilizing network function virtualization (NFV) and software defined networking (SDN). Using edge cloud may mean access node operations to be carried out, at least partly, in a computing system operationally coupled to a remote radio head (RRH) or a radio unit (RU) 103 of an access node 104. It is also possible that access node operations may be performed on a distributed computing system or a cloud computing system located at the access node 104. Application of cloud RAN architecture enables RAN real-time functions being carried out at the radio access network (e.g., in a DU 105), and non-real-time functions being carried out in a centralized manner (e.g., in a CU 108).

5G (or new radio, NR) wireless communication networks may support multiple hierarchies, where multi-access edge computing (MEC) servers may be placed between the core network 110 and the access node 104. It should be appreciated that MEC may be applied in LTE wireless communication networks as well.

A 5G wireless communication network (“5G network”) may also comprise a non-terrestrial communication network, such as a satellite communication network, to enhance or complement the coverage of the 5G radio access network. For example, satellite communication may support the transfer of data between the 5G radio access network and the core network 110, enabling more extensive network coverage. Possible use cases may include: providing service continuity for machine-to-machine (M2M) or Internet of Things (IoT) devices or for passengers on board of vehicles, or ensuring service availability for critical communications, and future railway, maritime, or aeronautical communications. Satellite communication may utilize geostationary earth orbit (GEO) satellite systems, or low earth orbit (LEO) satellite systems, such as mega-constellations (i.e., systems in which hundreds of (nano)satellites are deployed). Alternatively, the satellites may be an airborne devices, such as an unmanned aerial vehicle (UAV), or a high-altitude platform system (HAPS). A given satellite 106 may provide communication services on Earth via one or more satellite beams. The one or more satellite beams create one or more cells over a given service area that may be bounded by the field of view of the satellite 106.

It is obvious for a person skilled in the art that the access node 104 depicted in FIG. 1 is just an example of a part of a radio access network, and in practice the radio access network may comprise a plurality of access nodes 104, the UEs 100, 102 may have access to a plurality of radio cells, and the radio access network may also comprise other apparatuses, such as physical layer relay access nodes or other entities. At least one of the access nodes may be a Home eNodeB or a Home gNodeB. A Home gNodeB or a Home eNodeB is a type of access node that may be used to provide indoor coverage inside a home, office, or other indoor environment.

Additionally, in a geographical area of a radio access network, a plurality of different kinds of radio cells as well as a plurality of radio cells may be provided. Radio cells may be macro cells (or umbrella cells) which may be large cells having a diameter of up to tens of kilometers, or smaller cells such as micro-, femto-or picocells. The access node(s) 104 of FIG. 1 may provide any kind of these cells. A cellular radio network may be implemented as a multilayer access networks including several kinds of radio cells. In multilayer access networks, one access node may provide one kind of a radio cell or radio cells, and thus a plurality of access nodes may be needed to provide such a multilayer access network.

For fulfilling the need for improving performance of radio access networks, the concept of “plug-and-play” access nodes may be introduced. A radio access network, which may be able to use “plug-and-play” access nodes, may include, in addition to Home eNodeBs or Home gNodeBs, a Home Node B gateway (HNB-GW) (not shown in FIG. 1). An HNB-GW, which may be installed within an operator's radio access network, may aggregate traffic from a large number of Home eNodeBs or Home gNodeBs back to a core network 110 of the operator.

6G wireless communication networks are expected to adopt flexible decentralized and/or distributed computing systems and architecture and ubiquitous computing, with local spectrum licensing, spectrum sharing, infrastructure sharing, and intelligent automated management underpinned by mobile edge computing, artificial intelligence, short-packet communication and blockchain technologies. Key features of 6G may include intelligent connected management and control functions, programmability, integrated sensing and communication, reduction of energy footprint, trustworthy infrastructure, scalability and affordability. In addition to these, 6G is also targeting new use cases covering the integration of localization and sensing capabilities into system definition to unifying user experience across physical and digital worlds.

Channel state information (CSI) refers to data about the current conditions of a wireless communication channel between a receiver (e.g., UE 100, 102) and a transmitter (e.g., access node 104). The access node 104 (e.g., gNB) may periodically, or aperiodically, transmit a channel state information reference signal (CSI-RS) to facilitate accurate channel measurements by the UE 100, 102. Based on the CSI-RS, the UE 100, 102 may measure various parameters related to the wireless channel, such as at least one of: channel quality, signal strength, interference levels, or channel characteristics. The UE 100, 102 may then report the CSI obtained from the measurements to the access node 104. The CSI report may provide information about the quality of the wireless channel between the UE 100, 102 and the access node 104 in order to optimize the performance of the network.

It should be noted that CSI-RS is just one example of a signal that can be measured by the receiver (e.g., a user device) to obtain the CSI. Alternatively, the CSI may be obtained from some other signal transmitted by the transmitter (e.g., a network device) and measured by the receiver. Some examples of the other signal may include at least one of: a synchronization signal or a synchronization signal block, a demodulation reference signal, or a cell-specific reference signal.

5G NR supports different types of CSI reporting, including periodic reporting, aperiodic reporting and event-triggered reporting. In periodic reporting, the UE 100, 102 regularly transmits CSI reports to the access node 104 at pre-defined or configured time intervals. The reporting interval can be configured based on, for example, network requirements, the mobility of the UE 100, 102, and/or network deployment scenarios.

In aperiodic reporting in 5G, the access node 104 may request the UE 100, 102 to report the latest channel conditions.

In event-triggered reporting, the UE 100, 102 may initiate CSI reporting when specific events occur, such as when there are significant changes in the channel conditions, or when requested by the access node 104.

The access node 104 can configure the UE 100, 102 with the CSI reporting parameters, such as reporting intervals, triggering events, and/or the number of CSI reports to be transmitted. These configurations may depend on the network deployment scenario, traffic conditions, and/or performance objectives.

The CSI reports transmitted by the UE 100, 102 comprise information about the measured channel conditions, for example at least one of: channel quality indicator (CQI), precoding matrix indicator (PMI), CSI-RS resource indicator (CRI), synchronization signal block resource indicator (SSBRI), layer indicator (LI), rank indicator (RI), L1 reference signal received power (RSRP), L1 reference signal received quality (RSRQ), L1 signal-to-interference-plus-noise ratio (SINR), capability index, or time-domain channel properties (TDCP).

The access node 104 may utilize the information from the CSI reports received from the UE 100, 102 for various purposes, such as adaptive beamforming, scheduling, resource allocation, and/or link adaptation. In this way, the access node 104 can make informed decisions based on the received CSI feedback to optimize the network performance and enhance the user experience.

Overall, CSI reporting enables spectral-efficient and adaptive communication in wireless networks. It allows the wireless network to dynamically adjust its resources and optimize the transmission parameters based on the real-time channel conditions, leading to improved network performance and enhanced user satisfaction.

By enabling CSI reporting at the MAC layer with uplink channel resources (e.g., physical uplink shared channel (PUSCH) resources or physical uplink control channel (PUCCH) resources, etc.), it is possible to support opportunistic CSI reporting. Herein the opportunistic CSI reporting means exploiting available resources, such as unused PUSCH resources, after mapping data to the transport block (TB). Instead of padding, it is possible to take advantage of these unused resources to transmit CSI. However, the full set of CSI may be larger than what can be transmitted on these unused resources. In this case, the unused resources can be used to transmit a “rough” CSI report (which may also be referred to as a short CSI report or a simplified CSI report) instead of the full CSI report. This is more efficient in terms of resource utilization and better than simple padding. It should be noted that the UE can include such a short CSI report in the PUSCH transmission whenever needed, and not necessarily only in the opportunistic manner described above.

However, there is a challenge in how to enable this kind of opportunistic or short CSI report. Some example embodiments address this challenge by providing a method for reporting an opportunistic or short CSI report that comprises rough CSI information. The short CSI report (or rough CSI report) may mean that the report does not comprise the full set of channel state information that would normally be included in a CSI report. In other words, the short CSI report may be a simplified version of the CSI report. For example, the short CSI report may include at least a part of the full set of CSI or indicate one or more changes to the previously reported CSI.

As an example, the short CSI report may indicate whether there is a change in at least a subset of CSI since the previously reported CSI. After receiving the short CSI report from the UE 100, 102, the network (e.g., access node 104) may determine which part(s) of the CSI remain unchanged and which part(s) have changed since the previous CSI report. The change may refer to a difference between the latest CSI value(s) and the previously reported CSI value(s) (e.g., the CSI may be considered as changed, if the difference or the changed information value is larger than a threshold). The network (e.g., access node 104) may further determine whether to transmit an uplink grant to the UE 100, 102 for requesting the full CSI information at least for the changed part(s).

Some example embodiments may enable the UE 100, 102 to report a small amount of CSI-related information efficiently and with reduced signalling overhead. Some example embodiments may also enable improved usage of radio resources, when using the padding CSI report (i.e., opportunistic reporting).

For example, the rough CSI information (or the short CSI report) may be delivered via a MAC subheader or a MAC control element (CE). The rough CSI information may be transmitted in an opportunistic manner whenever there are one or more unused radio resources in an uplink grant (this may also be referred to as a padding CSI report). Alternatively, the rough CSI information may be transmitted in a non-padding (non-opportunistic) manner (e.g., in the PUSCH resource(s)) based on UE determination.

A MAC CE is a type of control information exchanged between the UE 100, 102 and the access node 104. MAC CEs may be used to convey various control commands and status reports, such as buffer status reports, delay status reports and power headroom reports, which help to manage and optimize the network's resources and performance.

A MAC subheader is a part of the MAC protocol data unit (PDU). The MAC subheader may comprise information for managing data transmission, such as a logical channel identifier (LCID), length of the data, and/or other control elements. A given MAC subheader may correspond to a specific MAC service data unit (SDU), control element, or padding, helping to ensure proper data handling and resource allocation within the network. The LCID is a field (e.g., 6 bits in length) that uniquely identifies the logical channel associated with a specific MAC sub-PDU, control element, or padding.

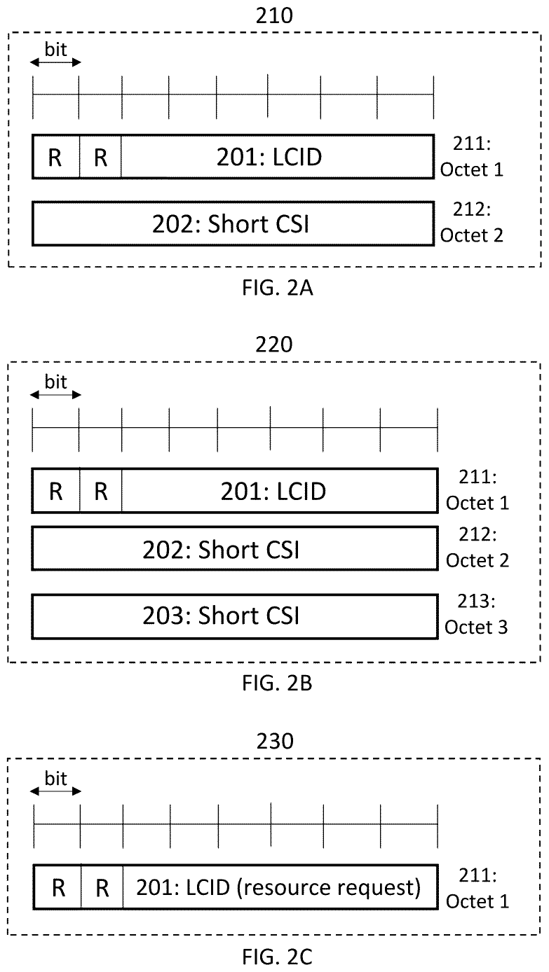

Multiple different short CSI reports can be defined (e.g., see FIG. 2A, FIG. 2B, and FIG. 2C), each with either a different size, different content, or both. In case of different sizes, the one that carries the largest number of bits that fit the available bits for transmission may be selected to be used. In case several short CSI reports of different sizes are present, one or more additional rules may be defined to select which CSI report to use and be transmitted. For example, in carrier aggregation, the UE may transmit a short CSI report for the cell or multiple cells, for which the time duration since the previous CSI transmission is the longest, or where there is a biggest change in the CQI, or where the PMI has changed, etc.

Some example embodiments are described below using principles and terminology of 5G radio access technology without limiting the example embodiments to 5G radio access technology, however.

FIG. 2A illustrates an example embodiment of a MAC subheader-based design for a short CSI report. In this example embodiment, the MAC subheader 210 for the short CSI report may be two octets 211, 212 (two bytes) in length. An octet is a unit of digital information that consists of eight bits. Herein the terms “octet” and “byte” may be used interchangeably.

The first octet 211 comprises two reserved bits (denoted as “R” in FIG. 2A), and an LCID field 201. The LCID field 201 may be used to indicate that the MAC subheader 210 is used for a short CSI report. The size of the LCID field 201 may be six bits, for example.

The reserved bits may be set to zero. As the length of the CSI MAC subheader is fixed, there is no need to include a “length” field and no need to include an “F” field (which would be used to indicate the length of the “length” field).

The second octet 212 comprises the rough (or short) CSI information 202 (i.e., the short CSI is one-octet long in this example embodiment). As an example, the short CSI 202 may comprise a bitmap, wherein each bit of the bitmap may be used to indicate whether or not there is a change in the corresponding subset of CSI compared to previously reported CSI (i.e., since the previous report time). Herein a subset of CSI refers to a certain type of CSI (e.g., CQI, RI, PMI, LI, L1-RSRP, or L1-RSRQ, etc.). Thus, the bits of the bitmap may be used to indicate which part(s) of the CSI has changed, or the bitmap may be for CSI profiles or modulars such that each bit corresponds to a certain CSI profile, which may be configured by the access node to the UE(s).

A bit with a value of one may indicate that there is a change in the corresponding subset of CSI, and a bit with a value of zero may indicate that there is no change in the corresponding subset of CSI. Alternatively, a bit with a value of zero may indicate that there is a change in the corresponding subset of CSI, and a bit with a value of one may indicate that there is no change in the corresponding subset of CSI.

As another example, the bit may indicate whether there is a negative change in the corresponding subset or type of CSI (e.g., channel quality becoming lower than a threshold). In this case, a bit with a value of one may indicate that there is a negative change in the corresponding subset of CSI, and a bit with a value of zero may indicate that there is no change or that there is a positive change (e.g., increase in channel quality) in the corresponding subset of CSI. Alternatively, a bit with a value of zero may indicate that there is a negative change in the corresponding subset of CSI, and a bit with a value of one may indicate that there is no change or that there is a positive change in the corresponding subset of CSI.

The structure of the bitmap may be UE-specific and configured to the UE by the network (e.g., by the access node 104). For example, the meaning of each bit of the bitmap may be configured to the UE via RRC signalling, since it may be dependent on UE capabilities, deployment scenarios, etc. Furthermore, one or more thresholds may be configured to the UE to determine whether there is a change in a corresponding subset of CSI (e.g., L1-RSRP may be considered as changed, if the difference between the latest L1-RSRP value and the previously reported L1-RSRP value is 2 dB or larger, where the value of 2 dB is used as an example of the threshold value.) Alternatively, the structure of the bitmap may be pre-defined (e.g., fixed in the specifications or hardcoded to the UE).

For example, the structure of the bitmap may be as follows:
Bit “0”: CQI (i.e., the first bit may indicate whether there is a change in CQI);
Bit “1”: RI (i.e., the second bit may indicate whether there is a change in RI);
Bit “2”: LI (i.e., the third bit may indicate whether there is a change in LI);
Bit “3”: PMI (i.e., the fourth bit may indicate whether there is a change in PMI);
Bit “4”: L1-RSRP (i.e., the fifth bit may indicate whether there is a change in L1-RSRP);
Bit “5”: L1-SINR (i.e., the sixth bit may indicate whether there is a change in L1-SINR);
Bit “6”: Beam indicator (i.e., the seventh bit may indicate whether there is a change in a beam indicator); and
Bit “7”: TDCP (i.e., the eighth bit may indicate whether there is a change in TDCP).

Alternatively, multiple bits (i.e., a set of at least two bits) may be defined for each subset or type of CSI (e.g., two bits for CQI, two bits for RI, and so on). In this case, additional information, such as a magnitude of the change, can be carried over the set of at least two bits.

The magnitude of the change indicates how much the value of the corresponding subset of CSI has changed since the previous CSI report. In other words, the magnitude of the change refers to the extent or degree of variation in the subset of CSI over time or due to changes in the environment.

A combination of multiple bits per subset of CSI (e.g., for CQI) and a single bit per subset of CSI (e.g., for LI-RSRP) is also possible. As an example, the one-octet long short CSI may combine one or more change indication bits (i.e., single bits) for one or more subsets of CSI (e.g., for RI), and a delta CQI (i.e., multiple bits indicating the magnitude of the change in CQI).

For example, the structure of the bitmap with such a combination may be as follows:
Bits “0, 1, 2, 3”: magnitude of CQI change relative to the previously reported CQI (e.g., −3, . . . , 4);
Bits “4,5”: magnitude of PMI change relative to the previously reported PMI (e.g., −1, 0, 1, 2);
Bit “6”: RI changed/not changed;
Bit “7”: LI changed/not changed.

FIG. 2B illustrates another example embodiment of a MAC subheader-based design for a short CSI report. In this example embodiment, the short CSI information 202, 203 in the MAC subheader 220 is carried over multiple octets 212, 213 (e.g., on the second octet 212 and on the third octet 213). The combination of the bits indicating the subset of the CSI may be configured by the network (e.g., gNB). This is different from the embodiment of FIG. 2A, wherein the short CSI 202 occupies only one octet 212. Each of the two octets 202, 203 may indicate different short CSI for a different cell or carrier.

FIG. 2C illustrates another example embodiment of a MAC subheader-based design for a short CSI report. In this example embodiment, the MAC subheader 230 comprises only one octet 211, and the LCID 201 is used as a resource request for requesting one or more radio resources from the access node 104 for reporting at least a subset of the CSI. In this case, once the access node 104 receives the MAC subheader 230, it knows that the UE 100, 102 would like to report CSI. The access node 104 may then transmit an uplink grant to the UE 100 to provide a sufficient amount of radio resources for transmitting the CSI report. In other words, the LCID 201 may indicate the type of MAC subheader (e.g., whether the MAC subheader comprises a short CSI report or not), and thus the LCID 201 may be considered as a resource request for reporting the full set of CSI (e.g., normal CSI report) from the UE 100.

In the example embodiments described above, a MAC subheader has been used as an example to design short CSI reporting. However, it should be noted that other options are also possible. For example, a MAC CE can be used for the short CSI report as an alternative to the MAC subheader. However, the signalling overhead with the MAC CE-based approach may be higher compared to the MAC subheader-based approach.

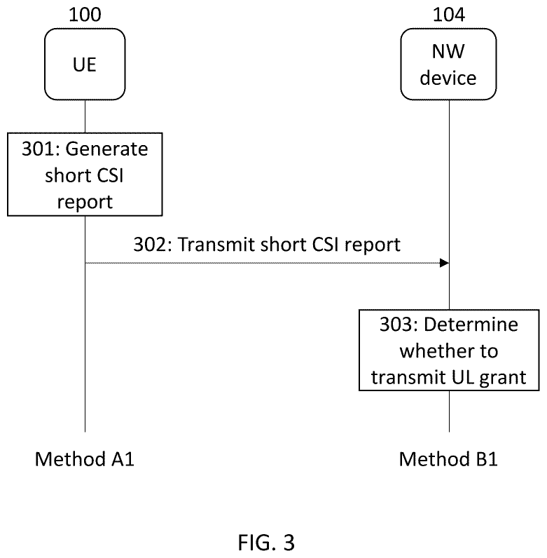

FIG. 3 illustrates a signal flow diagram according to an example embodiment.

Referring to FIG. 3, a user device 100 and a network device 104 are disclosed. The user device 100 may refer to the UE 100 of FIG. 1, and the network device 104 may refer to the access node 104 of FIG. 1.

In FIG. 3, there is provided a method A1 and a method B1 for short channel state information (short CSI) reporting.

The method A1 may be performed by an apparatus 900, such as the user device (i.e., UE) 100 or an apparatus comprised in the user device 100. According to a first aspect, the method A1 comprises at least the following.

Referring to FIG. 3, at 301, the user device 100 generates a report comprising information that indicates a change in at least a subset of channel state information compared to previously reported channel state information. The report may also be referred to as a short CSI report, a flag, an indication, or control information.

At 302, the user device 100 transmits the report to a network device 104 (e.g., access node 104), wherein the report is comprised in an in-band signalling message. An in-band signalling message is a type of control message that is transmitted within the same channel or frequency band as the main data (e.g., PUSCH). The in-band signaling message may be a MAC subheader or MAC CE or MAC PDU, for example.

According to a second aspect, there is provided the method A1 of the first aspect, further comprising: transmitting at least the subset of the channel state information to the network device 104.

According to a third aspect, there is provided the method A1 of the second aspect, further comprising: receiving, from the network device 104, after the report has been transmitted, an uplink grant for requesting at least the subset of the channel state information that is changed (or that is indicated as changed), wherein at least the subset of the channel state information is transmitted to the network device 104 based on the uplink grant.

According to a fourth aspect, there is provided the method A1 of any of the first to third aspects, further comprising: receiving, from the network device 104, configuration information indicating a structure of the report, wherein the report is generated based on the configuration information.

According to a fifth aspect, there is provided the method A1 of any of the first to fourth aspects, further comprising: evaluating the channel state information; and determining, based at least on the evaluation, whether to transmit the report, wherein the report is transmitted based on the determination.

The evaluation may comprise determining whether the change (e.g., a magnitude of the change) in at least the subset of the channel state information is larger than a threshold, wherein the report may be transmitted based on determining that the change (e.g., the magnitude of the change) is larger than the threshold.

According to a sixth aspect, there is provided the method A1 of any of the first to fifth aspects, further comprising: determining at least one of a size or a content of the report based on one or more configured rules.

The method B1 may be performed by an apparatus 1000, such as the network device 104 or an apparatus comprised in the network device 104. According to a seventh aspect, the method B1 comprises at least the following.

Referring to FIG. 3, at 302, the network device 104 receives, from a user device 100, a report comprising information that indicates a change in at least a subset of channel state information compared to previously reported channel state information, wherein the report is comprised in an in-band signalling message.

At 303, the network device 104 determines, based on the report, whether to transmit an uplink grant to the user device 100 for requesting at least the subset of the channel state information that is changed (or that is indicated as changed). In other words, the network device 104 may determine whether to request, from the user device 100, at least the subset of the channel state information that is changed.

It is noted that, if the user device 100 has data to transmit (other than the CSI), then the network device 104 may transmit the uplink grant to the user device 100 for scheduling a PUSCH transmission, regardless of whether or not the network device 104 determines to request at least the subset of the CSI that is changed. In this case, the uplink grant may comprise an indication for requesting at least the subset of the channel state information that is changed.

According to an eighth aspect, there is provided the method B1 of the seventh aspect, further comprising: transmitting the uplink grant to the user device 100 based on the determination (i.e., based on determining to transmit the uplink grant); and receiving at least the subset of the channel state information from the user device 100.

According to a ninth aspect, there is provided the method B1 of the seventh or eighth aspect, further comprising: transmitting, to the user device 100, configuration information indicating a structure of the report, wherein the report is based on the configuration information.

According to a tenth aspect, there is provided the method A1 of the fourth aspect or the method B1 of the ninth aspect, wherein the configuration information further indicates one or more thresholds for determining whether at least the subset of the channel state information is changed.

According to an eleventh aspect, there is provided the method A1 of any of the first to sixth or tenth aspects, or the method B1 of any of the seventh to tenth aspects, wherein the information in the report is carried on one or more octets, wherein at least one bit of the one or more octets indicates whether there is a change in a corresponding subset of the channel state information. For example, a binary value of a single bit may be used to indicate whether or not there is a change in a corresponding subset or type of the channel state information (e.g., each bit in the one or more octets may correspond to a different subset or type of the channel state information).

According to a twelfth aspect, there is provided the method A1 or method B1 of the eleventh aspect, wherein the at least one bit comprises a set of at least two bits that indicates a magnitude of the change in the corresponding subset of the channel state information. In other words, instead of a single bit, multiple bits (i.e., a set of at least two bits) may be used to represent a given subset or type of the channel state information. In this case, additional information, such as the magnitude of the change in the corresponding subset or type of the channel state information, can be carried over the set of at least two bits.

According to a thirteenth aspect, there is provided the method A1 or method B1 of any preceding aspect, wherein the report comprises a resource request requesting one or more radio resources for reporting at least the subset of the channel state information. In this case, the network device 104 may transmit the uplink grant to the user device 100 based on the resource request.

According to a fourteenth aspect, there is provided the method A1 or method B1 of any preceding aspect, wherein the report is comprised in a medium access control (MAC) subheader or in a MAC control element (CE).

According to another aspect, there is provided an apparatus 900 comprising one or more means for performing at least the method A1 of any of the first to sixth or eleventh to fourteenth aspects.

According to another aspect, there is provided an apparatus 1000 comprising one or more means for performing at least the method B1 of any of the seventh to fourteenth aspects.

According to another aspect, there is provided an apparatus 900 comprising at least one processor 910, and at least one memory 920 storing instructions that, when executed by the at least one processor 910, cause the apparatus 900 at least to perform the method A1 of any of the first to sixth or eleventh to fourteenth aspects.

According to another aspect, there is provided an apparatus 1000 comprising at least one processor 1010, and at least one memory 1020 storing instructions 1022 that, when executed by the at least one processor 1010, cause the apparatus 1000 at least to perform the method B1 of any of the seventh to fourteenth aspects.

According to another aspect, there is provided a computer program or a computer readable medium (e.g., a non-transitory computer readable medium) comprising program instructions which, when executed by an apparatus 900, cause the apparatus 900 to perform at least the method A1 of any of the first to sixth or eleventh to fourteenth aspects.

According to another aspect, there is provided a computer program or a computer readable medium (e.g., a non-transitory computer readable medium) comprising program instructions which, when executed by an apparatus 1000, cause the apparatus 1000 to perform at least the method B1 of any of the seventh to fourteenth aspects.

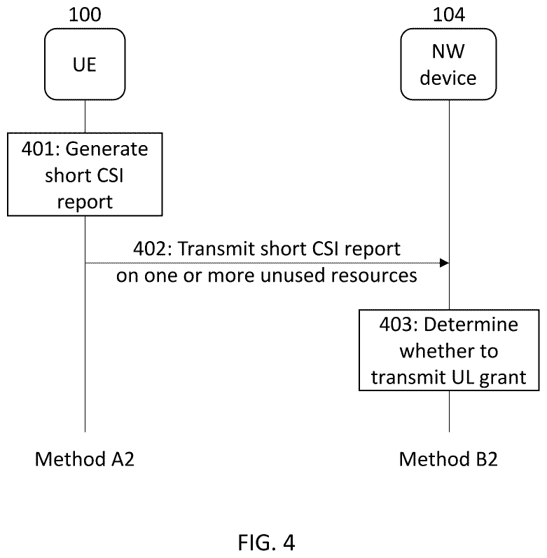

FIG. 4 illustrates a signal flow diagram according to an example embodiment.

Referring to FIG. 4, a user device 100 and a network device 104 are disclosed. The user device 100 may refer to the UE 100 of FIG. 1, and the network device 104 may refer to the access node 104 of FIG. 1.

In FIG. 4, there is provided a method A2 and a method B2 for opportunistic channel state information reporting.

The method A2 may be performed by an apparatus 900, such as the user device (i.e., UE) 100 or an apparatus comprised in the user device 100. According to a first aspect, the method A2 comprises at least the following.

Referring to FIG. 4, at 401, the user device 100 generates a report comprising information that indicates a change in at least a subset of channel state information compared to previously reported channel state information.

At 402, the user device 100 transmits the report in or within or together with an uplink transmission to a network device. For example, the report may be transmitted on one or more unused radio resources (e.g., time, frequency and/or spatial resources) from one or more radio resources allocated for the uplink transmission.

When a user device transmits data to the network in an uplink transmission, it is allocated specific radio resources (e.g., time, frequency and/or spatial resources) for this purpose. Sometimes, not all of these allocated resources are fully utilized by the data being transmitted. In such cases, any remaining unused radio resources can be efficiently used to transmit additional information, such as the report.

For example, the uplink transmission may refer to an uplink data transmission, such as a physical uplink shared channel (PUSCH) transmission, or a physical uplink control channel (PUCCH) transmission. The one or more unused radio resources may refer to radio resource(s) allocated for the uplink transmission but that are not used for transmitting the data associated with the uplink transmission. In other words, the report may occupy some of the allocated uplink resource(s) that are not used for the data transmission. This ensures efficient use of available resources by utilizing any leftover capacity.

If the report is included to the transport block (TB) in L2, such as a MAC subheader or MAC CE, then the report may be a part of the PUSCH. On the other hand, if the report is encoded separately and multiplexed with the PUSCH, then the report may be transmitted together with the PUSCH.

According to a second aspect, there is provided the method A2 of the first aspect, further comprising: determining the one or more unused radio resources based on an uplink grant received from the network device 104 for the uplink transmission. This uplink grant may also be referred to as a first uplink grant.

The uplink grant indicates the radio resource(s) allocated for the uplink transmission. By analysing this uplink grant, the user device 100 can determine which of the allocated resource(s) are not being fully utilized and can use these unused resource(s) to transmit the report.

According to a third aspect, there is provided the method A2 of the first or second aspect, further comprising: determining a size of the report based on a number of bits that can be carried on the one or more unused radio resources, wherein the report is generated according to the determined size.

For example, in case multiple different report structures with different sizes are available, then the report structure that carries the largest number of bits that can fit the available bits for transmission on the one or more unused radio resources may be selected for transmission.

According to a fourth aspect, there is provided the method A2 of any preceding aspect, further comprising: determining at least one of a size or a content of the report based on one or more configured rules. The one or more configured rules may be based on at least one of: a time duration since transmitting the previously reported channel state information, a predetermined magnitude of the change in at least the subset of the channel state information, or a change in a precoding matrix indicator compared to a precoding matrix indicator comprised in the previously reported channel state information for a corresponding cell.

For example, in carrier aggregation, the user device 100 may transmit the report for the cell or cells, for which the time duration since the previous CSI transmission is the longest, or where there is a biggest change in the CQI, or where the PMI has changed.

According to a fifth aspect, there is provided the method A2 of any preceding aspect, further comprising: transmitting at least the subset of the channel state information to the network device 104.

According to a sixth aspect, there is provided the method A2 of the fifth aspect, further comprising: receiving, from the network device 104, after the transmission of the report, an additional uplink grant for requesting at least the subset of the channel state information that is changed (or that is indicated as changed), wherein at least the subset of the channel state information is transmitted to the network device 104 based on the additional uplink grant.

The additional uplink grant may also be referred to as a second uplink grant. In other words, two or more uplink grants comprising the first uplink grant and the second uplink grant may be received by the user device in the overall procedure. For example, the format of the first uplink grant and the second uplink grant may be the same, but some of the fields in the second uplink grant may be set differently when requesting at least the subset of the CSI that is changed.

According to a seventh aspect, there is provided the method A2 of any preceding aspect, further comprising: receiving, from the network device 104, configuration information indicating a structure of the report, wherein the report is generated based on the configuration information.

According to an eighth aspect, there is provided the method A2 of any preceding aspect, further comprising: evaluating the channel state information; and determining, based at least on the evaluation, whether to transmit the report, wherein the report is transmitted based on the determination.

The evaluation may comprise determining whether the change (e.g., a magnitude of the change) in at least the subset of the channel state information is larger than a threshold, wherein the report may be transmitted based on determining that the change (e.g., the magnitude of the change) is larger than the threshold.

The method B2 may be performed by an apparatus 1000, such as the network device 104 or an apparatus comprised in the network device 104. According to a ninth aspect, the method B2 comprises at least the following.

Referring to FIG. 4, at 402, the network device 104 receives a report in or within or together with an uplink transmission from a user device 100, wherein the report comprises information that indicates a change in at least a subset of channel state information compared to previously reported channel state information.

At 403, the network device 104 determines, based on the report, whether to transmit an additional uplink grant to the user device 100 for requesting at least the subset of the channel state information that is changed (or that is indicated as changed). In other words, the network device 104 may determine whether to request, from the user device 100, at least the subset of the channel state information that is changed.

The additional uplink grant (second uplink grant) may refer to an uplink grant that is different from the uplink grant (first uplink grant) that may be transmitted to the user device 100 for the uplink transmission (prior to receiving the report and the uplink transmission).

According to a tenth aspect, there is provided the method B2 of the ninth aspect, further comprising: transmitting the additional uplink grant to the user device 100 based on the determination; and receiving at least the subset of the channel state information from the user equipment.

According to an eleventh aspect, there is provided the method B2 of the ninth or tenth aspect, further comprising: transmitting, to the user device 100, configuration information indicating a structure of the report, wherein the report is based on the configuration information.

According to a twelfth aspect, there is provided the method A2 of the seventh aspect or the method B2 of the eleventh aspect, wherein the configuration information further indicates one or more thresholds for determining whether at least the subset of the channel state information is changed.

According to a thirteenth aspect, there is provided the method A2 or method B2 of any preceding aspect, wherein the information is carried on one or more octets, wherein at least one bit of the one or more octets indicates whether there is a change in a corresponding subset of the channel state information.

According to a fourteenth aspect, there is provided the method A2 or method B2 of the thirteenth aspect, wherein the at least one bit comprises a set of at least two bits that indicates a magnitude of the change in the corresponding subset of the channel state information.

According to a fifteenth aspect, there is provided the method A2 or method B2 of any preceding aspect, wherein the report comprises a logical channel identifier indicating a resource request requesting one or more additional radio resources for reporting at least the subset of the channel state information.

According to a sixteenth aspect, there is provided the method A2 or method B2 of any preceding aspect, wherein the report is comprised in an in-band signalling message.

According to a seventeenth aspect, there is provided the method A2 or method B2 of any preceding aspect, wherein the report is comprised in a medium access control (MAC) subheader or in a MAC control element (CE).

According to another aspect, there is provided an apparatus 900 comprising one or more means for performing at least the method A2 of any of the first to eighth or twelfth to seventeenth aspects.

According to another aspect, there is provided an apparatus 1000 comprising one or more means for performing at least the method B2 of any of the ninth to seventeenth aspects.

According to another aspect, there is provided an apparatus 900 comprising at least one processor 910, and at least one memory 920 storing instructions that, when executed by the at least one processor 910, cause the apparatus 900 at least to perform the method A2 of any of the first to eighth or twelfth to seventeenth aspects.

According to another aspect, there is provided an apparatus 1000 comprising at least one processor 1010, and at least one memory 1020 storing instructions 1022 that, when executed by the at least one processor 1010, cause the apparatus 1000 at least to perform the method B2 of any of the ninth to seventeenth aspects.

According to another aspect, there is provided a computer program or a computer readable medium (e.g., a non-transitory computer readable medium) comprising program instructions which, when executed by an apparatus 900, cause the apparatus 900 to perform at least the method A2 of any of the first to eighth or twelfth to seventeenth aspects.

According to another aspect, there is provided a computer program or a computer readable medium (e.g., a non-transitory computer readable medium) comprising program instructions which, when executed by an apparatus 1000, cause the apparatus 1000 to perform at least the method B2 of any of the ninth to seventeenth aspects.

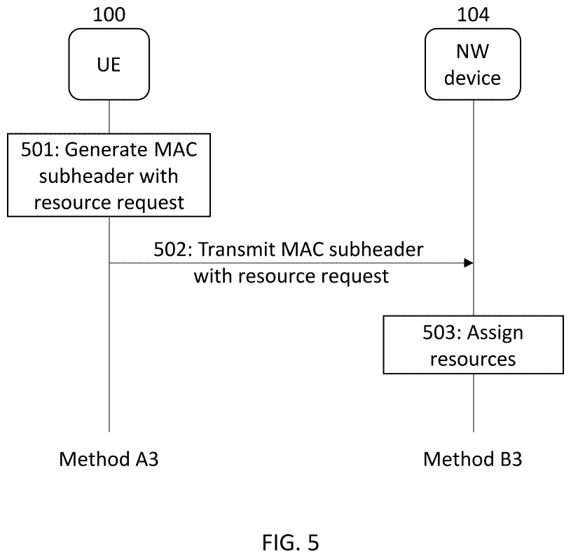

FIG. 5 illustrates a signal flow diagram according to an example embodiment.

Referring to FIG. 5, a user device 100 and a network device 104 are disclosed. The user device 100 may refer to the UE 100 of FIG. 1, and the network device 104 may refer to the access node 104 of FIG. 1.

In FIG. 5, there is provided a method A3 and a method B3 for including a resource request in a medium access control subheader.

The method A3 may be performed by an apparatus 900, such as the user device (i.e., UE) 100 or an apparatus comprised in the user device 100. According to a first aspect, the method A3 comprises at least the following.

Referring to FIG. 5, at 501, the user device 100 generates a medium access control subheader comprising a resource request requesting one or more radio resources for reporting at least a subset of channel state information.

At 502, the user device 100 transmits the medium access control subheader to a network device 104.

According to a second aspect, there is provided the method A3 of the first aspect, further comprising: receiving, from the network device 104, an uplink grant indicating the one or more radio resources for transmitting at least the subset of the channel state information, wherein the uplink grant is generated based on the medium access control subheader; and transmitting at least the subset of the channel state information to the network device 104 on the one or more radio resources indicated by the uplink grant.

The method B3 may be performed by an apparatus 1000, such as the network device 104 or an apparatus comprised in the network device 104. According to a third aspect, the method B3 comprises at least the following.

Referring to FIG. 5, at 502, the network device 104 receives, from a user device 100, a medium access control subheader comprising a resource request requesting one or more radio resources for reporting at least a subset of channel state information.

At 503, the network device 104 assigns, based on the resource request, the one or more radio resources to the user device 100 for reporting at least the subset of the channel state information.

According to a fourth aspect, there is provided the method B3 of the third aspect, further comprising: generating an uplink grant indicating the one or more radio resources for transmitting at least the subset of the channel state information; transmitting the uplink grant to the user device 100; and receiving at least the subset of the channel state information from the user device 100 on the one or more radio resources indicated by the uplink grant.

According to a fifth aspect, there is provided the method A3 or method B3 of any preceding aspect, wherein the medium access control subheader is carried on one octet.

According to a sixth aspect, there is provided the method A3 or method B3 of the fifth aspect, wherein the resource request is indicated by a logical channel identifier comprised in the one octet.

According to a seventh aspect, there is provided the method A3 or method B3 of any preceding aspect, wherein the medium access control subheader is delivered (i.e., transmitted by the user device 100 and received by the network device 104) on one or more unused radio resources from one or more radio resources allocated for an uplink transmission, wherein the medium access control subheader is delivered (i.e., transmitted by the user device 100 and received by the network device 104) within the uplink transmission. As another example, the medium access control subheader may be delivered on one or more radio resources allocated for the uplink transmission.

According to another aspect, there is provided an apparatus 900 comprising one or more means for performing at least the method A3 of any of the first, second, or fifth to seventh aspects.

According to another aspect, there is provided an apparatus 1000 comprising one or more means for performing at least the method B3 of any of the third to seventh aspects.

According to another aspect, there is provided an apparatus 900 comprising at least one processor 910, and at least one memory 920 storing instructions that, when executed by the at least one processor 910, cause the apparatus 900 at least to perform the method A3 of any of the first, second, or fifth to seventh aspects.

According to another aspect, there is provided an apparatus 1000 comprising at least one processor 1010, and at least one memory 1020 storing instructions 1022 that, when executed by the at least one processor 1010, cause the apparatus 1000 at least to perform the method B3 of any of the third to seventh aspects.

According to another aspect, there is provided a computer program or a computer readable medium (e.g., a non-transitory computer readable medium) comprising program instructions which, when executed by an apparatus 900, cause the apparatus 900 to perform at least the method A3 of any of the first, second, or fifth to seventh aspects.

According to another aspect, there is provided a computer program or a computer readable medium (e.g., a non-transitory computer readable medium) comprising program instructions which, when executed by an apparatus 1000, cause the apparatus 1000 to perform at least the method B3 of any of the third to seventh aspects.

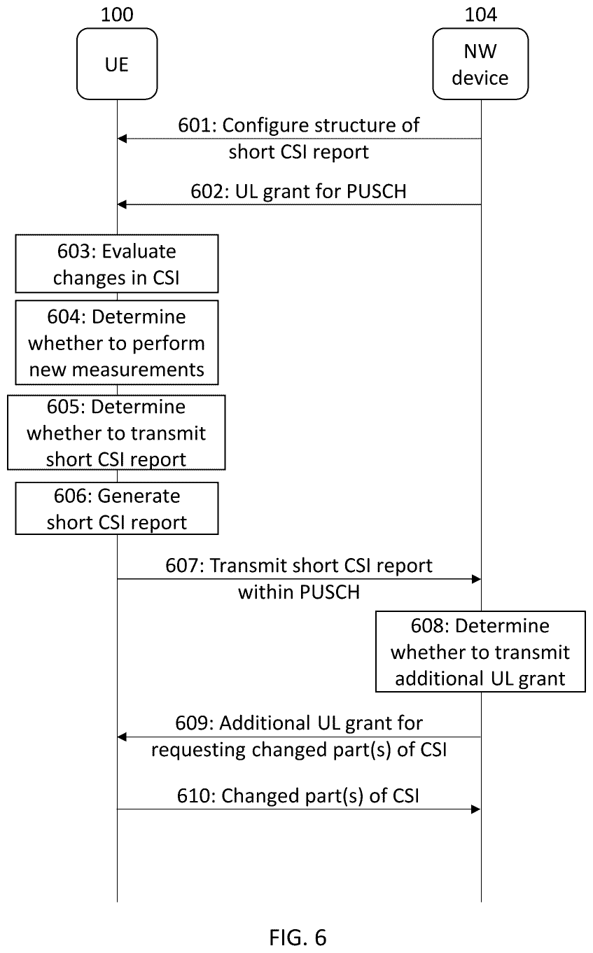

FIG. 6 illustrates a signal flow diagram according to an example embodiment.

Referring to FIG. 6, a user device 100 and a network device 104 are disclosed. The user device 100 may refer to the UE 100 of FIG. 1, and the network device 104 may refer to the access node 104 of FIG. 1.

At 601, the network device 104 may transmit, to the user device 100, configuration information indicating a structure of the short CSI report. The user device 100 may receive the configuration information. For example, the configuration information may indicate which subset or type of CSI corresponds to each bit in the bitmap described above. In case multiple bits are used for the same type of CSI information, additional configuration may occur as well (e.g., the meaning of each codepoint).

Alternatively, the structure of the short CSI report may be pre-defined, in which case the configuration information may not be transmitted to the user device 100.

At 602, the network device 104 may transmit, to the user device 100, an uplink grant for a PUSCH transmission. The uplink grant may be carried over a physical downlink channel, such as a physical downlink control channel (PDCCH) or a physical downlink shared channel (PDSCH).

At 603, the user device 100 may evaluate a set of channel state information (e.g., the present or latest channel state information available at the user device 100) to determine whether a change (e.g., a magnitude of the change) in at least a subset of the channel state information is larger than a threshold (the change being relative to previously reported channel state information). The threshold may be pre-defined or indicated in the configuration information. It should be noted that there may be a separate threshold for each subset (or type) of the channel state information.

In other words, the user device 100 may determine whether the set of channel state information (e.g., the present channel state information available at the user device 100) is valid. Herein the validity refers to the usefulness of the set of channel state information.

For example, the set of present channel state information may be considered as valid, if the change (e.g., the magnitude of the change) between the present channel state information and the previously reported channel state information is below the threshold. If the change is above the threshold, then the set of present channel state information may be considered as not valid.

Alternatively, or additionally, the validity may depend on the age of the CSI, for example such that the present CSI may be considered as valid, if the age of the CSI is below a validity time threshold (i.e., the CSI is up-to-date or not too old).

At 604, based on determining whether the set of channel state information is valid, the user device 100 may determine whether to perform one or more measurements for updating the set of channel state information prior to determining whether to transmit the report.

If the set of channel state information is not valid, then the user device 100 may perform the one or more measurements for updating the set of channel state information. The user device 100 may perform the one or more measurements based on one or more channel state information reference signals transmitted from the network device 104.

For example, the channel state information may comprise one or more values for at least one of: channel quality indicator (CQI), precoding matrix indicator (PMI), CSI-RS resource indicator (CRI), synchronization signal block resource indicator (SSBRI), layer indicator (LI), rank indicator (RI), L1 reference signal received power (RSRP), L1 reference signal received quality (RSRQ), L1 signal-to-interference-plus-noise ratio (SINR), capability index, or time-domain channel properties (TDCP).

Each subset of the channel state information may correspond to one or more of these CSI parameters. For example, one subset of the channel state information may comprise one or more CQI values, another subset of the channel state information may comprise one or more PMI values, and so on.

At 605, based at least on the evaluation, the user device 100 may determine whether to transmit, to the network device 104, a report (short CSI report) comprising information that indicates the change in at least the subset of the channel state information compared to previously reported channel state information (i.e., compared to the CSI previously reported from the user device 100 to the network device 104).

If the change (e.g., the magnitude of the change) in the set of present channel state information (which may have been updated at 604) is larger than the threshold, then the user device 100 may determine to transmit the report. Otherwise, the user device 100 may refrain from transmitting the report.

The determination of 605 may also take into account potential padding resource(s), i.e., whether there are unused radio resources available in the radio resources allocated for the PUSCH transmission in the uplink grant.

At 606, based on determining to transmit the report, the user device 100 generates the report (e.g., based on the configuration information). The user device 100 may determine a content of the report based on the evaluation of the channel state information (i.e., based on whether the change in a given subset or type of the CSI is larger than the threshold defined for that subset or type of the CSI).

For example, if the change in the latest CQI value compared to the previously reported CQI value is larger than the threshold defined for the CQI change, then the report may indicate that there is a change in the CQI. As another example, if the change in the latest CQI value compared to the previously reported CQI value is smaller than the threshold defined for the CQI change, then the report may indicate that there is no change in the CQI.

At 607, the user device 100 may transmit the report to the network device 104 (based on determining that the change is larger than the threshold). The network device 104 receives the report. The report may not comprise the actual channel state information, but just an indication of whether at least the subset of the channel state information is changed, and/or an indication of the magnitude of the change compared to the previously reported channel state information.

The report may be transmitted in or within or together with the PUSCH transmission, for which the uplink grant was received at 602. For example, the report may be transmitted on one or more unused radio resources from one or more radio resources allocated for the PUSCH transmission. The user device 100 may determine the one or more unused radio resources based on, for example, the uplink grant received from the network device 104.

The report may be comprised in an in-band signalling message. For example, the report may be comprised in a medium access control (MAC) subheader or in a MAC control element (CE).

At 608, the network device 104 may determine, based on the report, whether to transmit an additional uplink grant to the user device 100 for requesting at least the subset of the channel state information that is changed (or that is indicated as changed). In other words, the network device 104 may determine whether or not to request the updated channel state information from the user device 104. For example, if the report indicates that there is a change in at least the subset of the channel state information, then the network device 104 may determine to transmit the additional uplink grant to the user device 100. Alternatively, if the report indicates that there is no change or a small change (less than the threshold) in the channel state information, then the network device 104 may determine to refrain from transmitting the additional uplink grant to the user device 100.

As another example, the network device 104 may use the delta information (i.e., the magnitude of the change) to adapt, for example, the modulation coding scheme (MCS) determination in subsequent scheduling decisions.

At 609, the network device 104 may transmit the additional uplink grant to the user device 100 based on determining to transmit the additional uplink grant. The additional uplink grant may be carried over a PDCCH.

At 610, based on the additional uplink grant, the user device 100 may transmit at least the subset of the channel state information (which was indicated as changed in the report) to the network device 104.

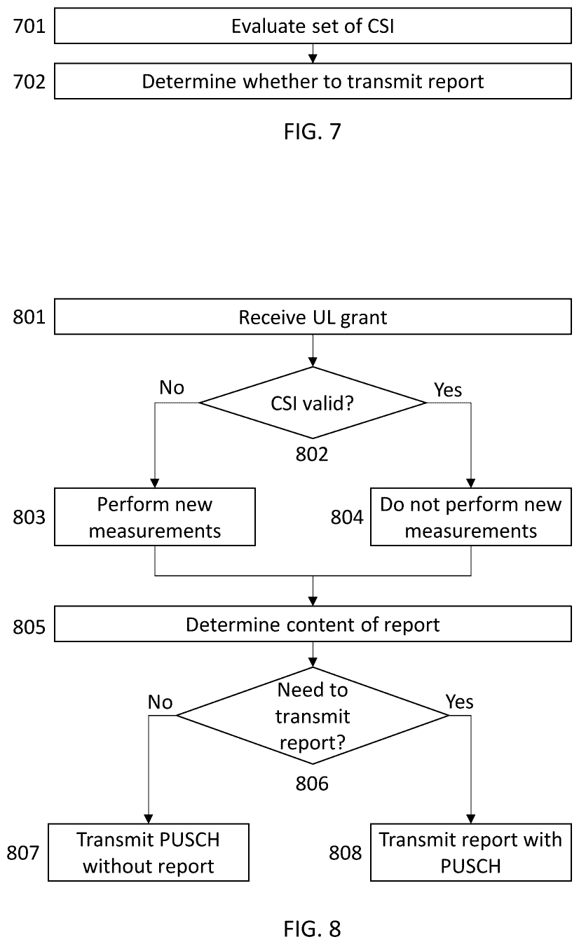

FIG. 7 illustrates a flow chart according to an example embodiment of a method A4 for determining whether to transmit a short channel state information report.

The method A4 may be performed by an apparatus 900, such as the user device (i.e., UE) 100 or an apparatus comprised in the user device 100. According to a first aspect, the method A4 comprises at least the following.

Referring to FIG. 7, in block 701, the apparatus 900 evaluates a set of channel state information.

In block 702, the apparatus 900 determines, based at least on the evaluation, whether to transmit, to a network device 104, a report comprising information that indicates a change in at least a subset of the channel state information compared to previously reported channel state information.

According to a second aspect, there is provided the method A4 of the first aspect, further comprising: determining whether the set of channel state information is valid; and, based on determining whether the set of channel state information is valid, determine whether to perform one or more measurements for updating the set of channel state information prior to determining whether to transmit the report.

According to a third aspect, there is provided the method A4 of the second aspect, further comprising: performing the one or more measurements for updating the set of channel state information, based on determining that the set of channel state information is not valid.

According to a fourth aspect, there is provided the method A4 of any preceding aspect, wherein the evaluation comprises determining whether (the magnitude of) the change in at least the subset of the channel state information is larger than a threshold, wherein the method A4 further comprises: determining a content of the report based on the change; and transmitting the report to the network device 104, based on determining that (the magnitude of) the change is larger than the threshold.

According to a fifth aspect, there is provided the method A4 of any of the first to third aspects, wherein the evaluation comprises determining whether (the magnitude of) the change in at least the subset of the channel state information is larger than a threshold, wherein the method A4 further comprises: refraining from transmitting the report to the network device 104, based on determining that (the magnitude of) the change is not larger than the threshold.

According to a sixth aspect, there is provided the method A4 of the fourth or fifth aspect, further comprising: receiving, from the network device 104, configuration information indicating the threshold for determining whether (the magnitude of) the change in at least the subset of the channel state information is larger than the threshold.

According to a seventh aspect, there is provided the method A4 of any preceding aspect, wherein the report is comprised in an in-band signalling message.

According to an eighth aspect, there is provided the method A4 of any preceding aspect, wherein the report is comprised in a medium access control (MAC) subheader or in a MAC control element (CE).

According to a ninth aspect, there is provided the method A4 of any preceding aspect, further comprising: receiving, from the network device 104, based on transmitting the report, an uplink grant for requesting at least the subset of the channel state information that is changed (or that is indicated as changed); and transmitting at least the subset of the channel state information to the network device 104 based on the uplink grant.

According to a tenth aspect, there is provided the method A4 of any preceding aspect, further comprising: receiving, from the network device 104, configuration information indicating a structure of the report; and generating the report based on the configuration information.

According to an eleventh aspect, there is provided the method A4 of any preceding aspect, further comprising: determining at least one of a size or a content of the report based on one or more configured rules.

According to a twelfth aspect, there is provided the method A4 of any preceding aspect, wherein the information is carried on one or more octets, wherein at least one bit of the one or more octets indicates whether there is a change in a corresponding subset of the channel state information.

According to a thirteenth aspect, there is provided the method A4 of the twelfth aspect, wherein the at least one bit comprises a set of at least two bits that indicates a magnitude of the change in the corresponding subset of the channel state information.

According to a fourteenth aspect, there is provided the method A4 of any preceding aspect, wherein the report further comprises a resource request requesting one or more radio resources for reporting at least the subset of the channel state information.

According to another aspect, there is provided an apparatus 900 comprising one or more means for performing at least the method A4 of any of the first to fourteenth aspects.

According to another aspect, there is provided an apparatus 900 comprising at least one processor 910, and at least one memory 920 storing instructions that, when executed by the at least one processor 910, cause the apparatus 900 at least to perform the method A4 of any of the first to fourteenth aspects.

According to another aspect, there is provided a computer program comprising instructions which, when executed by an apparatus 900, cause the apparatus 900 to perform at least the method A4 of any of the first to fourteenth aspects.

According to another aspect, there is provided a computer readable medium comprising program instructions which, when executed by an apparatus 900, cause the apparatus 900 to perform at least the method A4 of any of the first to fourteenth aspects.

According to another aspect, there is provided a non-transitory computer readable medium comprising program instructions which, when executed by an apparatus 900, cause the apparatus 900 to perform at least the method A4 of any of the first to fourteenth aspects.

FIG. 8 illustrates a flow chart according to an example embodiment of a method A5 for determining whether to transmit a short channel state information report.

The method A5 may be performed by an apparatus 900, such as the user device (i.e., UE) 100 or an apparatus comprised in the user device 100.

Referring to FIG. 8, in block 801, the apparatus 900 receives, from a network device 104, an uplink grant for a PUSCH transmission. The uplink grant may be carried over a physical downlink control channel (PDCCH).

In block 802, after receiving the uplink grant, the apparatus 900 evaluates a set of channel state information (e.g., the present channel state information available at the apparatus 900) to determine whether the set of channel state information is valid.

For example, the apparatus 900 may determine whether a change (e.g., a magnitude of the change) in at least a subset of the channel state information is larger than a threshold (the change being relative to previously reported channel state information). The set of present channel state information may be considered as valid, if the change (e.g., the magnitude of the change) between the present channel state information and the previously reported channel state information is below the threshold. If the change is above the threshold, then the set of present channel state information may be considered as not valid.

Based on determining whether the set of channel state information is valid, the apparatus 900 may determine whether to perform one or more (new) CSI measurements for updating the set of channel state information prior to determining whether to transmit the report.

In block 803, based on determining that the set of channel state information is not valid (block 802: no), the apparatus 900 may perform the one or more (new) CSI measurements for updating the set of channel state information. The apparatus 900 may perform the one or more CSI measurements based on one or more channel state information reference signals transmitted from the network device 104.

Alternatively, in block 804, based on determining that the set of channel state information is valid (block 802: yes), the apparatus 900 may refrain from performing the one or more (new) measurements.

In block 805, following block 803 or 804, the apparatus 900 may determine a content of the report to see what the report would look like (based on the present or updated channel state information, depending on whether the one or more new measurements were performed). For example, the content of the report may be determined for each subset of the (present or updated) channel state information based on whether the change (e.g., the magnitude of the change) in that subset is larger than the corresponding threshold (relative to the previously reported channel state information). There may be a separate threshold defined for each subset (or type) of the channel state information.

Even if no new measurements are needed, the CSI content may have changed relative to the previously reported CSI value(s). Furthermore, if the new measurement(s) are performed, it does not necessarily mean that the CSI has changed more than the threshold.

In block 806, based at least on evaluating the set of present or updated channel state information, the apparatus 900 determines whether to transmit, to the network device 104, a report (short CSI report) comprising information that indicates a change in at least a subset of the channel state information compared to the previously reported channel state information. In other words, the apparatus 900 determines whether there is a need to transmit the report.

For example, if (the magnitude) of the change in the present or updated channel state information compared to the previously reported channel state information is larger than the threshold, then the apparatus 900 may determine to transmit the report. Otherwise, the apparatus 900 may refrain from transmitting the report.

If the one or more new measurements were performed in block 803, then the set of updated channel state information may be compared to the previously reported channel state information in order to determine whether the change (e.g., the magnitude of the change) in the set of updated channel state information (relative to the previously reported channel state information) is larger than the threshold.

If the CSI was determined as not valid in block 802 (the change is larger than the threshold) and the one or more new measurements were performed to update the CSI, then it is possible that the change in the updated CSI compared to the previously reported CSI is no longer larger than the threshold (since the CSI values may change closer to the previously reported CSI values after the update). In this case, the apparatus 900 may determine to refrain from transmitting the short CSI report (thus reducing signalling overhead), even if the CSI was earlier considered as not valid. Alternatively, if the change (e.g., the magnitude of the change) in the updated CSI compared to the previously reported CSI is larger than the threshold, then the apparatus 900 may determine to transmit the report.

In block 807, based on determining to not transmit the report (block 806: no), the apparatus 900 refrains from transmitting the report, i.e., the apparatus 900 transmits the PUSCH transmission to the network device 104 without the report.

Alternatively, in block 808, based on determining to transmit the report (block 806: yes), the apparatus 900 generates and transmits the report to the network device 104 in or within or together with the PUSCH transmission. The report may be comprised in an in-band signalling message. For example, the report may be comprised in a medium access control (MAC) subheader or in a MAC control element (CE).

The blocks, functions, and information exchanges (messages) described above by means of FIG. 3 to FIG. 8 are in no absolute chronological order, and some of them may be performed simultaneously or in an order differing from the described one. Other functions can also be executed between them or within them, and other information may be sent, and/or other rules applied. Some of the blocks or part of the blocks or one or more pieces of information can also be left out or replaced by a corresponding block or part of the block or one or more pieces of information.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

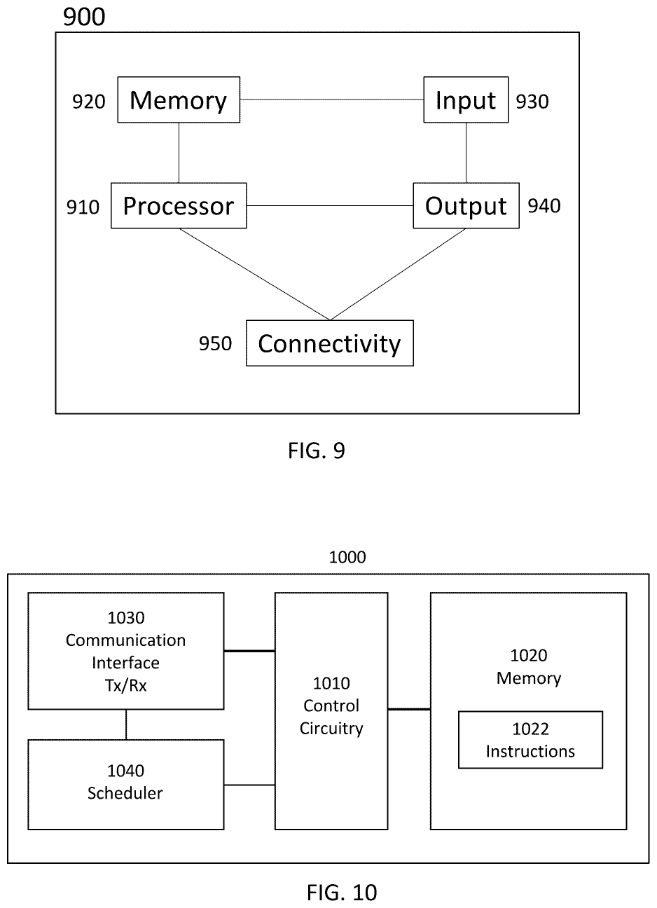

FIG. 9 illustrates an example of an apparatus 900 comprising means for performing one or more of the example embodiments described above (e.g., any of the methods A1, A2, A3, A4 and/or A5). For example, the apparatus 900 may be an apparatus such as, or comprising, or comprised in, the user device 100.

The apparatus 900 may comprise a circuitry or a chipset applicable for realizing one or more of the example embodiments described above. For example, the apparatus 900 may comprise at least one processor 910. The at least one processor 910 interprets instructions (e.g., computer program instructions) and processes data. The at least one processor 910 may comprise one or more programmable processors. The at least one processor 910 may comprise programmable hardware with embedded firmware and may, alternatively or additionally, comprise one or more application-specific integrated circuits (ASICs).

The at least one processor 910 is coupled to at least one memory 920. The at least one processor is configured to read and write data to and from the at least one memory 920. The at least one memory 920 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The at least one memory 920 stores computer readable instructions that are executed by the at least one processor 910 to perform one or more of the example embodiments described above. For example, non-volatile memory stores the computer readable instructions, and the at least one processor 910 executes the instructions using volatile memory for temporary storage of data and/or instructions. The computer readable instructions may refer to computer program code.

The computer readable instructions may have been pre-stored to the at least one memory 920 or, alternatively or additionally, they may be received, by the apparatus, via an electromagnetic carrier signal and/or may be copied from a physical entity such as a computer program product. Execution of the computer readable instructions by the at least one processor 910 causes the apparatus 900 to perform one or more of the example embodiments described above. That is, the at least one processor and the at least one memory storing the instructions may provide the means for providing or causing the performance of any of the methods and/or blocks described above.

In the context of this document, a “memory” or “computer-readable media” or “computer-readable medium” may be any non-transitory media or medium or means that can contain, store, communicate, propagate or transport the instructions for use by or in connection with an instruction execution system, apparatus, or device, such as a computer. The term “non-transitory,” as used herein, is a limitation of the medium itself (i.e., tangible, not a signal) as opposed to a limitation on data storage persistency (e.g., RAM vs. ROM).

The apparatus 900 may further comprise, or be connected to, an input unit 930. The input unit 930 may comprise one or more interfaces for receiving input. The one or more interfaces may comprise, for example, at least one of: one or more temperature, motion and/or orientation sensors, one or more cameras, one or more accelerometers, one or more microphones, one or more buttons and/or one or more touch detection units. Further, the input unit 930 may comprise an interface to which external devices may connect to.

The apparatus 900 may also comprise an output unit 940. The output unit may comprise or be connected to one or more displays capable of rendering visual content, such as a light emitting diode (LED) display, a liquid crystal display (LCD) and/or a liquid crystal on silicon (LCoS) display. The output unit 940 may further comprise one or more audio outputs. The one or more audio outputs may be for example loudspeakers.

The apparatus 900 further comprises a connectivity unit 950. The connectivity unit 950 enables wireless connectivity to one or more external devices. The connectivity unit 950 comprises at least one transmitter and at least one receiver that may be integrated to the apparatus 900 or that the apparatus 900 may be connected to. The at least one transmitter comprises at least one transmission antenna, and the at least one receiver comprises at least one receiving antenna. The connectivity unit 950 may comprise an integrated circuit or a set of integrated circuits that provide the wireless communication capability for the apparatus 900. Alternatively, the wireless connectivity may be a hardwired application-specific integrated circuit (ASIC). The connectivity unit 950 may also provide means for performing at least some of the blocks or functions of one or more example embodiments described above. The connectivity unit 950 may comprise one or more components, such as: power amplifier, digital front end (DFE), analog-to-digital converter (ADC), digital-to-analog converter (DAC), frequency converter, (de)modulator, and/or encoder/decoder circuitries, controlled by the corresponding controlling units.

It is to be noted that the apparatus 900 may further comprise various components not illustrated in FIG. 9. The various components may be hardware components and/or software components.

FIG. 10 illustrates an example of an apparatus 1000 comprising means for performing one or more of the example embodiments described above (e.g., any of the methods B1, B2 and/or B3). For example, the apparatus 1000 may be an apparatus such as, or comprising, or comprised in, the network device 104 (e.g., an access node of a radio access network).

The apparatus 1000 may comprise, for example, a circuitry or a chipset applicable for realizing one or more of the example embodiments described above. The apparatus 1000 may be an electronic device comprising one or more electronic circuitries. The apparatus 1000 may comprise a communication control circuitry 1010 such as at least one processor, and at least one memory 1020 storing instructions 1022 which, when executed by the at least one processor, cause the apparatus 1000 to carry out one or more of the example embodiments described above. Such instructions 1022 may, for example, include computer program code (software). The at least one processor and the at least one memory storing the instructions may provide the means for providing or causing the performance of any of the methods and/or blocks described above.

The processor is coupled to the memory 1020. The processor is configured to read and write data to and from the memory 1020. The memory 1020 may comprise one or more memory units. The memory units may be volatile or non-volatile. It is to be noted that there may be one or more units of non-volatile memory and one or more units of volatile memory or, alternatively, one or more units of non-volatile memory, or, alternatively, one or more units of volatile memory. Volatile memory may be for example random-access memory (RAM), dynamic random-access memory (DRAM) or synchronous dynamic random-access memory (SDRAM). Non-volatile memory may be for example read-only memory (ROM), programmable read-only memory (PROM), electronically erasable programmable read-only memory (EEPROM), flash memory, optical storage or magnetic storage. In general, memories may be referred to as non-transitory computer readable media. The term “non-transitory,” as used herein, is a limitation of the medium itself (i.e., tangible, not a signal) as opposed to a limitation on data storage persistency (e.g., RAM vs. ROM). The memory 1020 stores computer readable instructions that are executed by the processor. For example, non-volatile memory stores the computer readable instructions, and the processor executes the instructions using volatile memory for temporary storage of data and/or instructions.

The computer readable instructions may have been pre-stored to the memory 1020 or, alternatively or additionally, they may be received, by the apparatus, via an electromagnetic carrier signal and/or may be copied from a physical entity such as a computer program product. Execution of the computer readable instructions causes the apparatus 1000 to perform one or more of the functionalities described above.

The memory 1020 may be implemented using any suitable data storage technology, such as semiconductor-based memory devices, flash memory, magnetic memory devices and systems, optical memory devices and systems, fixed memory and/or removable memory. The memory may comprise a configuration database for storing configuration data, such as a current neighbour cell list, and, in some example embodiments, structures of frames used in the detected neighbour cells.

The apparatus 1000 may further comprise or be connected to a communication interface 1030, such as a radio unit, comprising hardware and/or software for realizing communication connectivity with one or more wireless communication devices according to one or more communication protocols. The communication interface 1030 comprises at least one transmitter (Tx) and at least one receiver (Rx) that may be integrated to the apparatus 1000 or that the apparatus 1000 may be connected to. The communication interface 1030 may provide means for performing some of the blocks and/or functions (e.g., transmitting and receiving) for one or more example embodiments described above. The communication interface 1030 may comprise one or more components, such as: power amplifier, digital front end (DFE), analog-to-digital converter (ADC), digital-to-analog converter (DAC), frequency converter, (de)modulator, and/or encoder/decoder circuitries, controlled by the corresponding controlling units.

The communication interface 1030 provides the apparatus with radio communication capabilities to communicate in the wireless communication network. The communication interface may, for example, provide a radio interface to one or more UEs 100, 102. The apparatus 1000 may further comprise or be connected to another interface towards a core network 110, such as the network coordinator apparatus or AMF, and/or to other access nodes of the wireless communication network.

The apparatus 1000 may further comprise a scheduler 1040 that is configured to allocate radio resources. The scheduler 1040 may be configured along with the communication control circuitry 1010 or it may be separately configured.

It is to be noted that the apparatus 1000 may further comprise various components not illustrated in FIG. 10. The various components may be hardware components and/or software components.

As used in this application, the term “circuitry” may refer to one or more or all of the following: a) hardware-only circuit implementations (such as implementations in only analog and/or digital circuitry); and b) combinations of hardware circuits and software, such as (as applicable): i) a combination of analog and/or digital hardware circuit(s) with software/firmware and ii) any portions of hardware processor(s) with software (including digital signal processor(s), software, and memory(ies) that work together to cause an apparatus, such as a mobile phone, to perform various functions); and c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of example embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (for example procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

It will be understandable to a person skilled in the art that, as technology advances, the proposed concept may be implemented in various ways within the scope of the claims. The embodiments are not limited to the example embodiments described above, but may vary within the scope of the claims. Therefore, all words and expressions should be interpreted broadly, and they are intended to illustrate, not to restrict, the embodiments.

1. An apparatus comprising at least one processor, and at least one memory storing instructions that, when executed by the at least one processor, cause the apparatus at least to:
evaluate a set of channel state information; and
determine, based at least on the evaluation, whether to transmit, to a network device, a report comprising information that indicates a change in at least a subset of the channel state information compared to previously reported channel state information.

2. The apparatus of claim 1, further being caused to:
determine whether the set of channel state information is valid; and
based on determining whether the set of channel state information is valid, determine whether to perform one or more measurements for updating the set of channel state information prior to determining whether to transmit the report.

3. The apparatus of claim 2, further being caused to:
perform the one or more measurements for updating the set of channel state information, based on determining that the set of channel state information is not valid.

4. The apparatus of claim 1, wherein the evaluation comprises determining whether the change in at least the subset of the channel state information is larger than a threshold,
wherein the apparatus is further caused to:
determine a content of the report based on the change; and
transmit the report to the network device, based on determining that the change is larger than the threshold.

5. The apparatus of claim 4, further being caused to:
receive, from the network device, configuration information indicating the threshold for determining whether the change in at least the subset of the channel state information is larger than the threshold.

6. The apparatus of claim 1, wherein the report is transmitted on one or more unused radio resources from one or more radio resources allocated for an uplink transmission,
wherein the report is transmitted within or together with the uplink transmission.

7. The apparatus of claim 1, wherein the evaluation comprises determining whether the change in at least the subset of the channel state information is larger than a threshold,
wherein the apparatus is further caused to:
refrain from transmitting the report to the network device, based on determining that the change is not larger than the threshold.

8. The apparatus of claim 7, further being caused to:
receive, from the network device, configuration information indicating the threshold for determining whether the change in at least the subset of the channel state information is larger than the threshold.

9. The apparatus of claim 1, wherein the report is comprised in an in-band signalling message.

10. The apparatus of claim 1, wherein the report is comprised in a medium access control, MAC, subheader or in a MAC control element, CE.

11. The apparatus of claim 1, further being caused to:
receive, from the network device, based on transmitting the report, an uplink grant for requesting at least the subset of the channel state information that is changed; and
transmit at least the subset of the channel state information to the network device based on the uplink grant.

12. The apparatus of claim 1, further being caused to:
receive, from the network device, configuration information indicating a structure of the report; and
generate the report based on the configuration information.

13. The apparatus of claim 1, further being caused to:
determine at least one of a size or a content of the report based on one or more configured rules.

14. The apparatus of claim 1, wherein the information is carried on one or more octets,
wherein at least one bit of the one or more octets indicates whether there is a change in a corresponding subset of the channel state information.

15. The apparatus of claim 14, wherein the at least one bit comprises a set of at least two bits that indicates a magnitude of the change in the corresponding subset of the channel state information.

16. The apparatus of claim 1, wherein the report further comprises a resource request requesting one or more radio resources for reporting at least the subset of the channel state information.

17. A method comprising:
evaluating a set of channel state information; and
determining, based at least on the evaluation, whether to transmit, to a network device, a report comprising information that indicates a change in at least a subset of the channel state information compared to previously reported channel state information.

18. The method of claim 17, further comprising:
determining whether the set of channel state information is valid; and
based on determining whether the set of channel state information is valid, determining whether to perform one or more measurements for updating the set of channel state information prior to determining whether to transmit the report.

19. The method of claim 17, wherein the evaluation comprises determining whether the change in at least the subset of the channel state information is larger than a threshold,
wherein the method further comprises:
determining a content of the report based on the change; and
transmitting the report to the network device, based on determining that the change is larger than the threshold.

20. A non-transitory computer readable medium comprising program instructions which, when executed by an apparatus, cause the apparatus to perform at least the following:
evaluating a set of channel state information; and
determining, based at least on the evaluation, whether to transmit, to a network device, a report comprising information that indicates a change in at least a subset of the channel state information compared to previously reported channel state information.
